(19) United States
(12) Patent Application Publication
(10) Pub. No.: US 2009/0094753 A1
(43) Pub. Date: Apr. 16, 2009

(54) Elevate-Um

(76) Inventor: Lisa Ann Parker, Pineville, NC (US)

Correspondence Address: Lisa A. Parker, 12515 Aden Creek Way, Pineville, NC, 28134, US

(21) Appl. No.: 11/893,411

(22) Filed: Oct. 15, 2007

(51) Int. Cl. A47C 31/00; F16M 11/24

(52) U.S. Cl. 5/658; 248/188.2

(57) ABSTRACT

The Elevat-Um is a mechanical lifting setup used for raising and lowering the mattress of an infant's crib. The fact that the mattress will be raised to a more accessible level will help prevent back strain and injury from lowering a baby into a crib. The mattress frame will be fastened to four hydraulic lifters and controlled by a simple set of buttons (up and down) that will be mounted to the crib, or a remote control that will be included in the upgraded version. The lifters will be connected to the corners of the mattress frame and to a support rail that will sit on the floor. The power source will be placed under the crib and be plugged into any standard wall outlet.

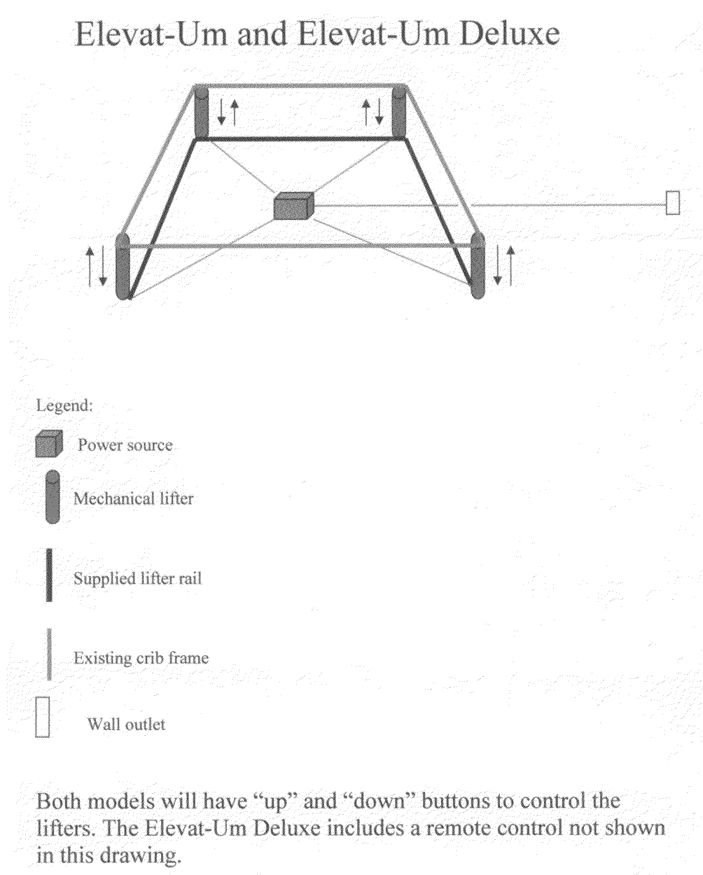

This device will allow the mattress of an infant crib to be raised and lowered, to ease in the placement of infants for parents, using four (4) hydraulic lifting pistons. The invention is designed to be sold as an individual unit that may be retro-fitted onto an existing crib.

The lifters will be anchored to the mattress frame and also attached to a support rail system that will be included in the kit that sits on the floor under the crib. The range of the Elevat-Um Deluxe will be the same as the Elevat-Um with the difference being you can stop the lifters anywhere in the range of motion (up, down, anywhere in between). The four lifters will be wired into a main power unit that will fit under the crib and the power unit will be controlled by a button for lifting as well as a separate button for lowering. These buttons will be able to be attached to the crib in any location the user feels appropriate as well as the addition of a battery operated remote control. The power unit will plug into a standard wall outlet and all exposed wires will be enclosed in a wire shield that will come with the kit. All fittings will be located under the mattress and out of the reach of infants and/or toddlers while in the crib.

1. The Elevat-Um is an original idea by Lisa Parker that allows the mattress of an infant's crib to be raised and lowered as needed to aid parents with placing an infant in the crib. The mattress of the crib will be raised by four (4) mechanical or hydraulic pistons and will be controlled by crib mounted buttons or remote control. Any parents or anyone placing the baby in the crib will benefit from this device. The invention will help prevent back strain from bending over and will allow any mother who has had a cesarean delivery, an easer way of putting the baby to sleep. After looking at all the existing crib designs that are available I am unable to find anything that resembles my design.
